(19) United States
(12) Patent Application Publication
(10) Pub. No.: US 2005/0105288 A1
(43) Pub. Date: May 19, 2005

(54) Decorative lamp set

(76) Inventor: Chen-Yuan Chen, Hsinchu City (TW)

Correspondence Address: TROXELL LAW OFFICE PLLC, SUITE 1404, 5205 LEESBURG PIKE, FALLS CHURCH, VA, 22041, US

(21) Appl. No.: 10/986,855

(22) Filed: Nov. 15, 2004

(30) Foreign Application Priority Data
Nov. 18, 2003 (CN) 2003201043533

(51) Int. Cl. F21V 21/00

(52) U.S. Cl. 362/249; 362/806; 362/808

(57) ABSTRACT

A decorative lamp set comprises at least two main parts of which one is larger and the other is smaller, a plurality of secondary parts and decorative lamps; wherein the main parts have skeleton structures convenient for assembling and slipping over one another, the secondary parts are detachably provided on these main parts using fixing devices. Thereby the main parts of different sizes can mutually connect by slipping one over another and to have all but one part received in a largest main part for collapsing into a smaller volume; the lamp set thus is convenient for transporting and storing, and its structure is simple for fast production and assembling.

### BACKGROUND OF THE INVENTION

1. Field of the Invention

The present invention is related to a decorative lamp set, and especially to a decorative lamp set able to have its various main parts mutually connected by slipping one over another and to have all of its various main parts received in a largest main part for collapsing into a smaller volume. It is convenient for transporting and storing and its structure is simple for fast production and assembling. The decorative lamp set is applicable for arrangement of a scene background for various festivals.

2. Description of the Prior Art

People are used to decorating livinghood with flowers and lamp sets. Conventional decorative lamp sets generally are divided into two kinds, one is the kind of craft lamp set that adopts an outer structure of any of various modeling of art having lamp bulbs mounted therein, for example decorative lanterns and palace lanterns etc. These decorative lamp sets must be set up manually and their structures are not firm. Further, because of their larger volumes, they can only suitable to be set up in large public fields and they are inconvenient for transporting and storing. Second is the kind of lamp string. Although its structure is more simple and it is convenient for assembling and fixing on a building or a tree. Its modeling is monotonic and lacks the character of vividness and variety.

In view of this, the inventor developed the present invention after diligent contemplation and study to overcome the above defects of the conventional lamp sets structures.

### SUMMARY OF THE INVENTION

The main objective of the present invention is to provide a decorative lamp set able to have all of its various main parts received in a largest main part. It is convenient for transporting and storing. Its structure is simple for fast production and assembling.

In order to achieve the above objective, the decorative lamp set of the present invention comprises at least two main parts of which one is larger and the other is smaller, a plurality of secondary parts and decorative lamps, wherein the main parts have skeleton structures convenient for assembling and slipping over one another, the secondary parts are detachably provided on these main parts using fixing devices.

The present invention will be apparent after reading the detailed description of the preferred embodiment thereof in reference to the accompanying drawings.

### BRIEF DESCRIPTION OF THE DRAWINGS

FIG. 1 is a schematic view showing the structure of an embodiment of a decorative lamp set of the present invention;

FIG. 2 is an analytic schematic view showing the embodiment of the decorative lamp set of the present invention;

FIG. 3 is a schematic view showing the embodiment of the present invention after collapsing of various main parts of the embodiment;

FIG. 3A is a schematic view showing another embodiment of the decorative lamp set of the present invention after collapsing of various main parts of this embodiment;

FIG. 3B is a schematic view showing the appearance of a decorative lamp set of the present invention wrapped therearound with tinsel garlands;

FIG. 3C is a schematic view showing the appearance of a decorative lamp set of the present invention provided thereover with transparent layers;

FIG. 4 is a schematic view showing a pivot structure between two main parts of the embodiment of the decorative lamp set of the present invention;

FIG. 5 is a perspective view showing the structure of a fixing engaging member of the embodiment of the decorative lamp set of the present invention;

FIG. 6 is a perspective view showing the structure of a line binding member of the embodiment of the decorative lamp set of the present invention;

FIG. 7 is a perspective view showing the state of clamping of an elastic clamp of the embodiment of the decorative lamp set of the present invention; and

FIG. 8 is a schematic view partially showing the structure of a third embodiment of the present invention.

### DETAILED DESCRIPTION OF THE PREFERRED EMBODIMENT

The decorative lamp set of the present invention comprises at least two main parts of which one is larger and the other is smaller, a plurality of secondary parts and decorative lamps, wherein the main parts have skeleton structures convenient for assembling and slipping over one another, the secondary parts are detachably provided on these main parts using fixing devices.

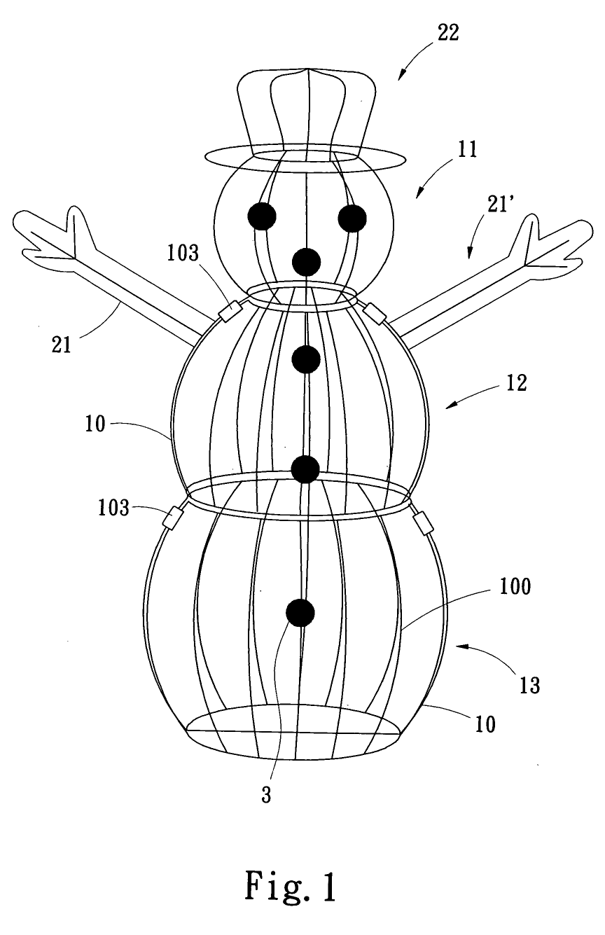

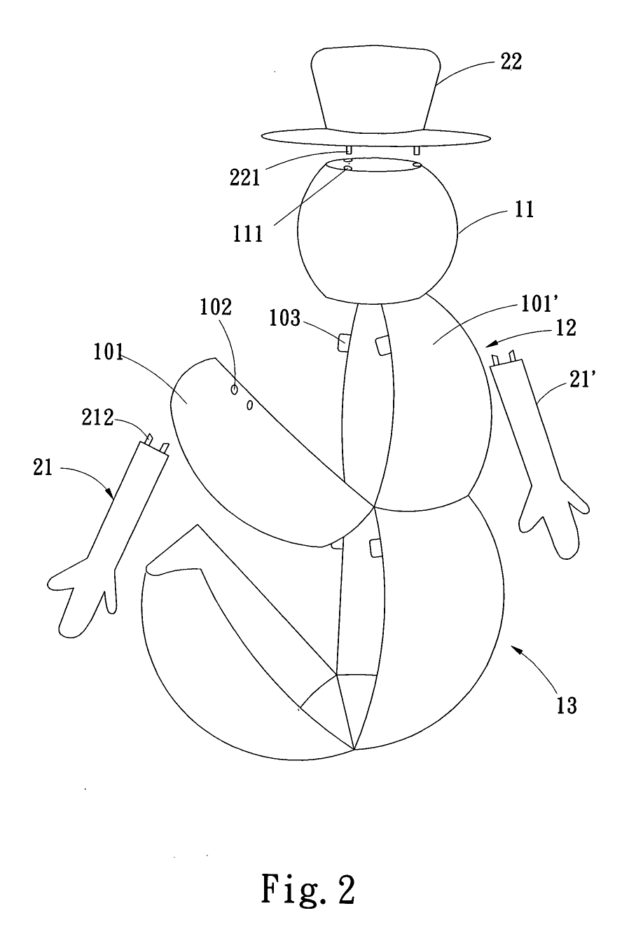

Referring to FIGS. 1, 2 showing an example of the shape of a snowman that comprises three main parts, namely, a head 11, a chest 12 and an abdomen 13, wherein the skeleton structures 10 of the main parts are partial spherical hollow members formed from arciform members able to be opened or detached; in this embodiment, each skeleton structure 10 is formed from two arciform members 101, 101′ being mutually connected using a hinge on their bottom ends, the arciform members 101, 101′ can be formed by welding of iron strips, the two vertical edges of the arciform member 101′ have position limiting engaging portions 103, while the head 11 can be directly formed by welding of iron strips into a shape of a hollow sphere to simplify the process of production and assembling.

The decorative lamp set of the embodiment further has a plurality of secondary parts including a hat 22 and two arms 21, 21′ etc. The secondary parts can be fixedly connected with the main parts by any of various ways, such as an insertion mode using pins inserting into insertion holes, or a hooking mode using fixing hooks to hook into fixing holes etc.; the embodiment adopts the former insertion mode, i.e., the joint of the hat 22 with the head 11 has a plurality of pins 221, while the head 11 has correspondingly on its top insertion holes 111. Certainly, the insertion holes 111 and the pins 221 can be exchanged by position, namely, the pins 221 are provided on the head 11, while the insertion holes 111 are provided on the hat 22. The mode of fixing of the arms 21, 21′ can be same as the connecting mode of the hat 22 with the head 11; the snowman can be added with ornaments such as a muffler, a pair of gloves etc. to make its contour richer and more colorful.

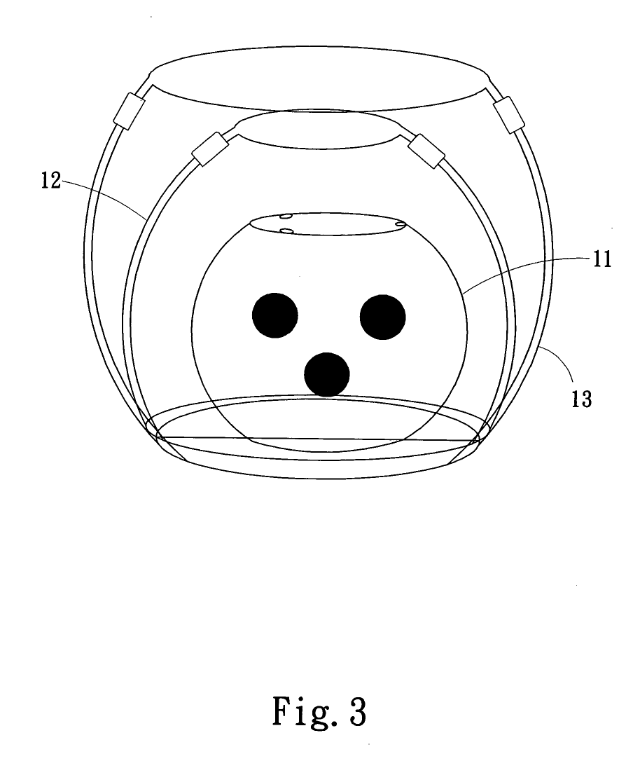

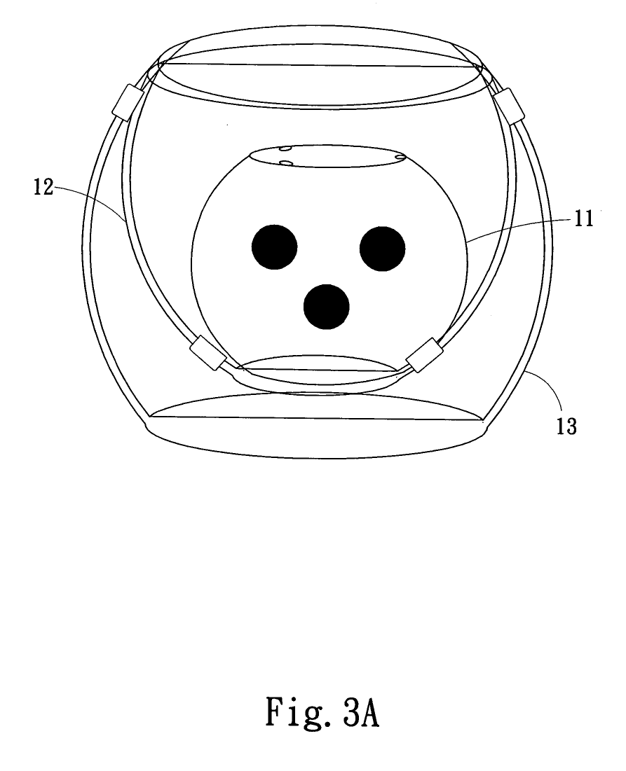

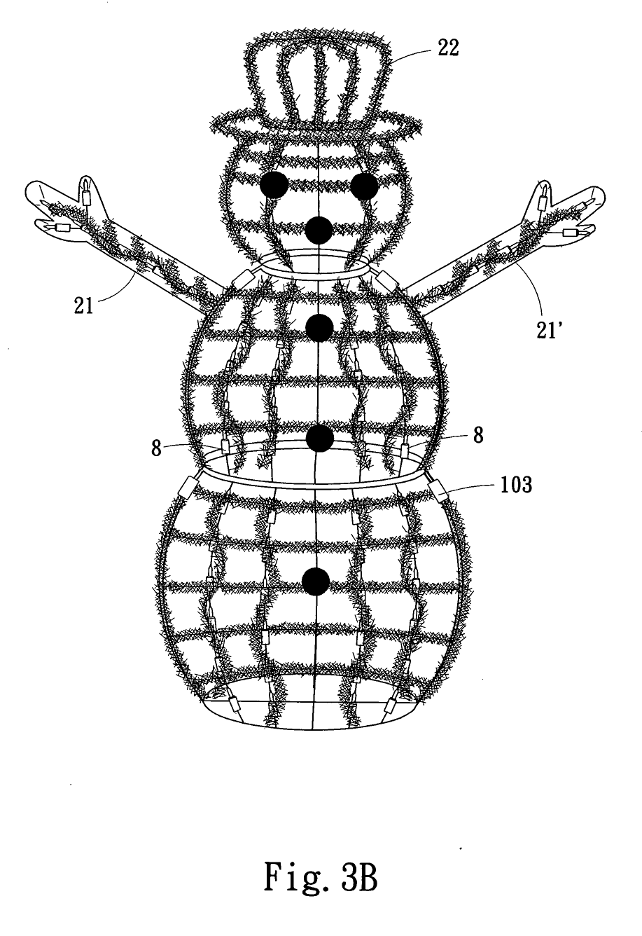

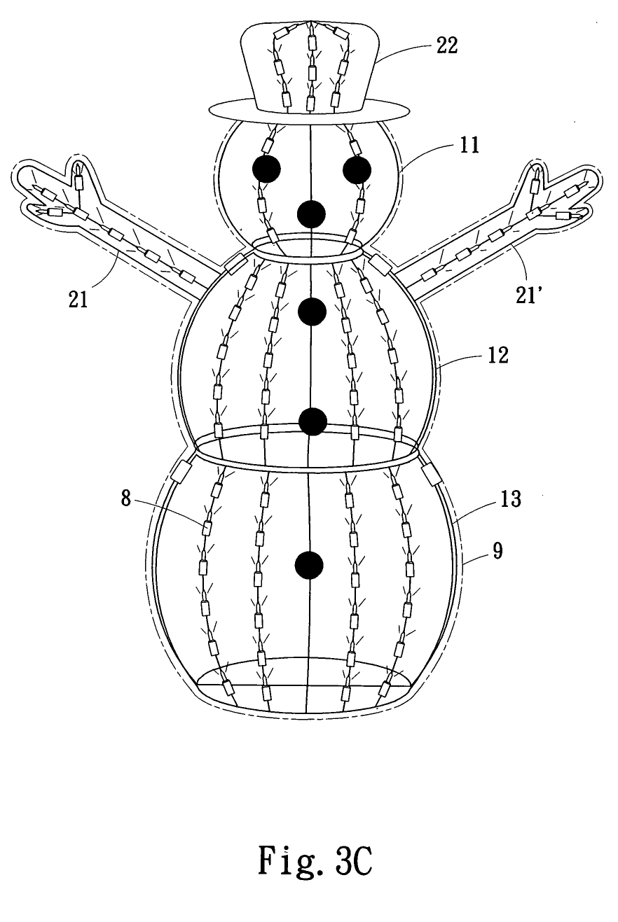

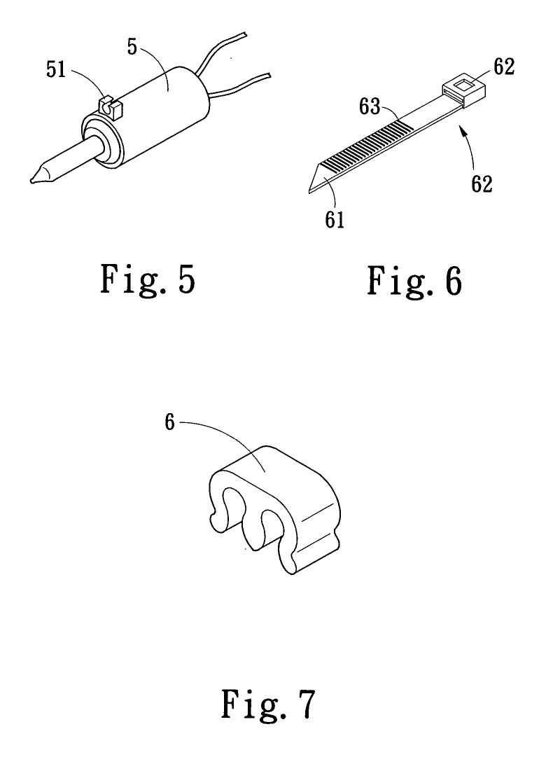

Moreover, the above stated decorative lamp set can be wrapped with plastic ropes, wild rattans, tinsel garlands or ribbons (as shown in FIG. 3B), or it is coated on its entire surface with an EVA or PVC transparent layer 9 (as shown in FIG. 3C). The decorative lamps of the present invention can make lamp strings 8 that are fixed on the decorative lamp set by any of various ways; the electric wires of the lamp strings 8 can be fixed on plastic ropes, wild rattans, tinsel garlands or ribbons using fixing engaging members 5 on the lamp string 8 as shown in FIG. 5 or using line binding members 6 as shown in FIG. 6; wherein the fixing engaging members 5 each has an engaging portion 51 to catch an iron wire, while the line binding members 6 have thereon protrusions 63 and allow their free ends 61 to extend into their holes 62 for engagement without being subjected to releasing. Thereby the decorative lamps can be provided for viewing and admiring through refraction of the abovementioned articles.

In mounting the present invention, in the first place, the main parts including the head 11, the chest 12 and the abdomen 13 are connected together; wherein the position limiting engaging portions 103 on the edges of the arciform members 101′ can limit and engage the arciform members 101, and can be further fixed by using the fixing engaging members 5 or some elastic clamps 6′ as shown in FIG. 7, and then the hat 22, the arms 21, 21′ can be respectively inserted and fixed on the head 11 and the chest 12; and lastly, the snowman completed is wrapped with the lamp strings 8, after that, the arciform members 101 of the chest 12 and the abdomen 13 are opened to be collapsed for storing after use and ready for next-time use again; and when an electric power source is turned on, a shape of lifelike snowman appears.

In storing and transporting of the present invention, the decorative lamp set can be collapsed into the largest main part; in this embodiment, as shown in FIG. 3, the hat 22, the arms 21, 21′ can be detached in the first place, then all the main part are detached; the smallest head 11 is received in the larger chest 12, lastly, they are both received in the largest abdomen 13, in this mode, the volume of the snowman lamp set can be largely reduced in favor of storing and transporting.

The present invention uses the decorative lamp set as a light source, its entire illumination effect is good, its appearance is lifelike; and it is structurally simple, it is convenient and fast for production and assembling, the mode of fixing of the lamp strings is agile and can effectively protect the lamp holder; the lamp set is safer for transporting and use.

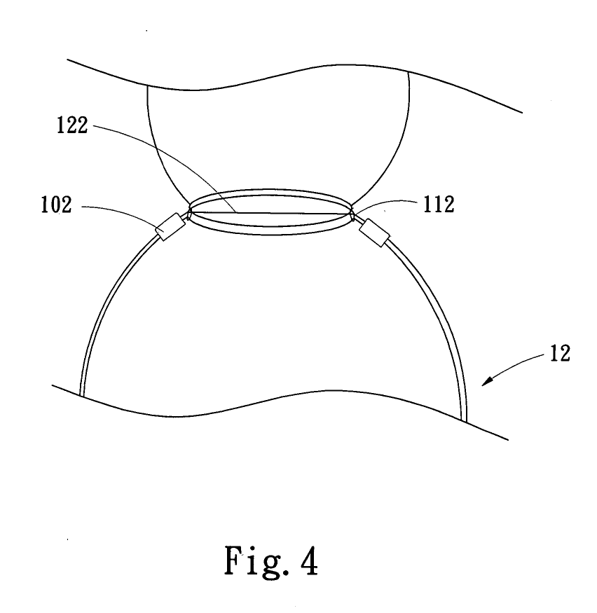

Further, the joints of the neighboring main parts of the present invention can be provided with pivot means, the pivot means can be round holes 112 provided on lateral bottom sides of each main part plus two shafts 122 provided on the top of a neighboring main part, such as is shown in FIG. 4. In this embodiment, each shaft 122 and an iron strip of a skeleton structure 10 form a shape “L”; the shafts 122 are extended into the round holes 112 to form the pivot means. Certainly, the positions of the round holes 112 and the shafts 122 can be exchanged, i.e., the round holes 112 are provided on the top of the main part, while the shafts 122 are provided on lateral bottom sides of a neighboring main part; each shaft 122 and an iron strip of a skeleton structure 10 form a shape “L”. And the shafts 122 provided on lateral bottom sides can be provided integrally such as is shown in FIG. 4; and can also be provided separately, that is, the lower main part can be provided laterally on the top thereof with the shafts 122 in corresponding by position to the two round holes 112, so long that the object of forming a pivot means can be attained.

Thereby, with the above stated pivot structures, in assembling the decorative lamp set, the main parts need to be processed for fixing in a simple way; while in collapsing, it needs only to open the lower main part, and to turn down the upper main part into the lower main part; when the main parts are engaged together, they are turned down into the next main part. In this embodiment, as shown in FIGS. 2, 3A, the arciform members 101′ of the head 11, the chest 12 and the abdomen 13 are connected and fixed only using the pivot means and the position limiting engaging portions 103, then the shafts 122 are extended into the round holes 112, the upper main part can thus be placed on the lower main part, and the two arciform members 101 are engaged and fixed using the position limiting engaging portions 103. Certainly, in order to make firmer connections between the periphery edges of the main parts, fixing engaging members 5 or elastic clamps 6′ can be used for further strengthening; and in collapsing, the secondary parts are detached in the first place from the main parts, then the connecting members (such as the fixing engaging members 5 or the elastic clamps 6′) of these main parts are removed, and the head 11 turned down into the opened chest main part 12, the chest main part 12 having therein the head 11 then is collapsed to be turned down in the same way into the opened abdomen main part 13.

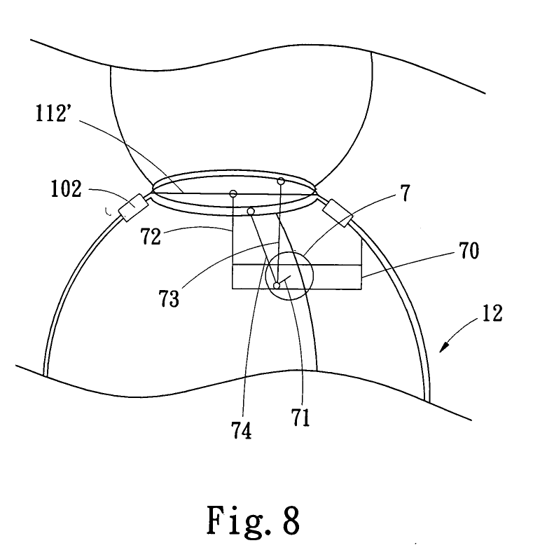

Besides, the chest main part 12 of the decorative lamp set of the present invention is provided therein with an electric machine 7; an output axle 71 of the electric machine 7 can be fixedly connected with the head 11 using a conventionally known structure to drive the head 11 for swinging. Referring to FIG. 8 which is a schematic view showing connecting of the head main part and the chest main part, wherein the head main part 11 has a predetermined distance from the top edge of the chest main part 12, the head main part 11 has on its bottom edge a shaft 112′; the chest main part 12 is provided therein with an electric machine 7 that can transmit the shaking action of the head 11, the electric machine 7 can be fixed using a support 70, the output axle 71 of the electric machine 7 can be movably connected with the bottom edge of the head 11 respectively via two links 73, 74; a fixed rod 72 has a lower end fixed on the support 70, its upper end is movably connected with the middle point of the abovementioned shaft 112′. With the above stated structure, when the electric machine 7 is activated, its output axle 71 can render the head 11 shake leftwards and rightwards at its position of mounting; when the head 11 is still, it is firmly supported by a three-point supporting structure formed from the fixed rod 72 and the two links 73, 74.

For the convenience of receiving the head main part 11 in the chest main part 12, the support 70 can be detachably fixed in the chest main part 12 using a conventionally known structure; while the fixed rod 72 and the two links 73, 74 can also be detachably fixed on the head main part 11 by the abovementioned way. Therefore, when in collapsing, it needs only that a swinging means formed from the support 70, the electric machine 7, the two links 73, 74 and the fixed rod 72 is detached from the head main part 11 and the chest main part 12, the action of collapsing can thus by executed.

Therefore, the present invention has the following advantages:

1. The main parts of the decorative lamp set of the present invention use connectable and detachable skeleton structures to allow the main parts of different sizes mutually connecting by slipping one over another and to have all but one part received in a largest main part for collapsing into a smaller volume; no matter the lamp set is designed to have a shape of a snowman or an animal, it is convenient for transporting and storing after collapsing.

2. The decorative lamp set of the present invention is used as a light source, its entire illumination effect is good, its appearance is lifelike. Its structure is simple for fast production and assembling. The mode of fixing the lamp strings is agile and can effectively protect the lamp holder. The lamp set is safer for transporting and use.

3. The decorative lamp set of the present invention can be wrapped therearound with plastic ropes, wild rattans, tinsel garlands or ribbons. Or it can be coated on its entire surface with an EVA or PVC transparent layer to elevate its esthetic beauty.

4. The present invention can be provided therein with an electric device to drive the main part swinging, so that the entire shape can be lively and vivid.

The above stated are only for disclosing the practicable embodiments of the present invention, and not for giving any limitation to the scope of the present invention. It will be apparent that various modifications or changes without departing from the spirit of this invention shall also fall within the scope of the appended claims.

According to the above description, the present invention surely can get the expected object to provide a decorative lamp set; having thus described my invention undoubtedly having its practicable value, what I claim as new and desire to be secured by Letters Patent of the United States are:

1. A decorative lamp set comprising at least two main parts of which one is larger and the other is smaller, a plurality of secondary parts and decorative lamps, wherein said secondary parts are detachably provided on said main parts using fixing devices.

2. The decorative lamp set as in claim 1, wherein said main parts have skeleton structures which each is composed at least of two arciform members being mutually movably connected on their bottom ends, wherein at least one of said arciform members has on its vertical edge a position limiting engaging portions.

3. The decorative lamp set as in claim 1, wherein joints of every two neighboring ones of said main parts are provided with pivot means, said pivot means are round holes and shafts provided respectively on lateral bottom sides of each of said main parts and on the top of a neighboring one of said main parts, each of said shafts is extended into one of said round holes to form one of said pivot means.

4. The decorative lamp set as in claim 1, wherein said fixing devices comprise pins, said main parts are provided with insertion holes for insertion of said pins.

5. The decorative lamp set as in claim 1, wherein said decorative lamp set is wrapped with plastic ropes, wild rattans, tinsel garlands or ribbons.

6. The decorative lamp set as in claim 5, wherein said decorative lamps make lamp strings that are fixed on said skeleton structures, plastic ropes, wild rattans, tinsel garlands or ribbons using fixing engaging members or elastic clamps.

7. The decorative lamp set as in claim 1, wherein said decorative lamp set is coated with an EVA or PVC transparent layer.

8. The decorative lamp set as in claim 1, wherein said fixing devices comprise fixing hooks provided on an end of each of said secondary parts and fixing holes provided on corresponding ones of said main parts; alternatively, said fixing devices comprise fixing holes provided on each of said secondary parts and fixing hooks provided on corresponding ones of said main parts.

9. The decorative lamp set as in claims 1, wherein said decorative lamp set has a shape of an animal.

10. The decorative lamp set as in claims 1, wherein said decorative lamp set has a shape of a snowman, and includes from its top to its bottom a head main part, a chest main part and an abdomen main part, every upper one of said main parts is smaller than every lower one of said main parts, every of said main parts with a smaller volume is adapted to receiving in every of said main parts with a larger volume.

11. The decorative lamp set as in claim 10, wherein said secondary parts include a hat provided on said head main part and two arms provided on said chest main part, said chest main part is provided therein with an electric machine adapted for swinging, said electric machine has an output axle being fixed on said head main part.

12. The decorative lamp set as in claim 1, wherein said decorative lamp set has a shape of a snowman that comprises a head main part, a chest main part and an abdomen main part, said main parts are partial spherical hollow members; wherein said skeleton structures of said chest and abdomen main parts each is formed from arciform members being mutually connected using a hinge on their bottom ends; two vertical edges of one of said arciform members have position limiting engaging portions; said secondary parts include a hat provided on said head main part and two arms provided on said chest main part; said fixing devices comprise pins, said main parts are provided with insertion holes for insertion of said pins; said decorative lamps make lamp strings, said skeleton structures are wrapped with plastic ropes, wild rattans, tinsel garlands or ribbons; said lamp strings are fixed on said skeleton structures, plastic ropes, wild rattans, tinsel garlands or ribbons using fixing engaging members or elastic clamps; said chest main part is provided therein with an electric machine adapted for swinging, said electric machine has an output axle being fixed on said head main part.
